(19) United States
(12) Patent Application Publication
(10) Pub. No.: US 2007/0109581 A1
(43) Pub. Date: May 17, 2007

(54) Information processing device and preview displaying method

(76) Inventor: Yutaka Saitoh, Saitama (JP)

Correspondence Address: DICKSTEIN SHAPIRO LLP, 1825 EYE STREET NW, Washington, DC, 20006-5403, US

(21) Appl. No.: 11/593,590

(22) Filed: Nov. 7, 2006

(30) Foreign Application Priority Data
Nov. 11, 2005 (JP) 2005-328176
Nov. 1, 2006 (JP) 2006-298261

(51) Int. Cl. G06F 3/12

(52) U.S. Cl. 358/1.13; 358/527

(57) ABSTRACT

An information processing device converts input document data into print data used to control a printer, and displays a print preview before outputting the print data to the printer. In the information processing device, a document data storing unit stores the input document data as intermediate data. A layout determining unit determines a layout of image data of the document data on an output sheet based on a specified printing method, so that layout information is created. A preview displaying unit displays a print preview on a computer screen based on the stored document data. A print data creating unit converts the input document data into the print data.

### BACKGROUND OF THE INVENTION

1. Field of the Invention

The present invention generally relates to an information processing device, such as a personal computer, and more particularly to an information processing device which converts document data into print data used to control a printer, and displays a print preview indicating a printed result of the print data, on a computer screen before the print data is outputted to the printer.

2. Description of the Related Art

In an information processing device (such as a personal computer) provided with a printer, the printer driver generally is adapted to convert the input document data into print data used to control the printer (or the print data in the form that can be interpreted by the printer). The main role of the printer driver is to convert the document data sent from an application program into print data (e.g., PDL (page description language) data) which are used to control the printer, and transmit the print data to the printer, so that a printed matter with the document image currently displayed on the application program is created.

In order to create a printed matter with the document image currently displayed on the application program, the printer driver is adapted to attain various print setting functions of the printer, including sheet feeding, paper output tray setting, double-sided print setting, and finishing setting. Moreover, the printer driver is adapted to attain other print setting functions, including expansion printing, reduction printing, intensive printing (which is the function to print an image of two or more print data arranged on a single sheet), and stamp printing (which is the function to print an image including an arbitrary image overlapped on a document page).

By making use of the printer driver, various print setting functions, in addition to printing of the document image currently displayed on the application program, can be provided.

However, there may be a case in which a printed result which is different from the document image expected by the user is created by using the functions provided by the printer driver. To obviate the problem, it is desirable to provide a preview function that enables checking of the printed result on the computer screen before the actual printing is performed.

Some application programs may have their own preview functions. In the case of such application programs, checking the document image of the printed result prior to printing is possible. However, the printed result which is created through the above-mentioned print setting functions provided by the printer driver cannot be realized only with the application program.

For this reason, there is an increasing demand for providing a printer driver (or print system) which has the preview function. And there is a proposed printer driver having the preview function.

Usually, the following two methods for realizing the preview function with the printer driver can be considered.

The 1st method is that PDL data are actually created from the input document data and an image of the created PDL data is displayed on the computer screen. In this case, since the preview displaying of the image of the PDL data which are actually transmitted to the printer is carried out, it is possible to display the image which is the same as the actual printed result.

However, in the case of the 1st method, the processing of converting the document data into the PDL data must be performed. Also, additional processing, including reduction, position movement, rotation, etc. may be required depending on the case. Therefore, it takes a comparatively long time between the inputting of the document data and the displaying of the image of the PDL data on the screen.

When the resulting document image by the preview displaying differs from the document image expected by the user, it is necessary to create PDL data again from the document data. Also in this case, a comparatively long time is required between the start of the creation of PDL data and the end of the preview displaying of the image of the PDL data on the screen.

The 2nd method is that the image data inputted from the application program is temporarily stored in the state before converting it into PDL data (or the state before processing of scaling etc.) and an image of the stored image data is displayed on the screen.

In the case of the 2nd method, the processing of converting the document data into PDL data is not performed, and it is possible to display the print preview on the screen in comparatively early timing.

However, in the case of the 2nd method, when displaying a final print image on the screen, the preview displaying unit has to create a display image beforehand by supposing the operation which will be performed by the PDL conversion processing. If the operational setting of the PDL conversion processing is changed, it is necessary to change the preview displaying unit to compensate for the change.

### SUMMARY OF THE INVENTION

According to one aspect of the invention, there is provided an improved information processing device in which the above-described problems are eliminated.

According to one aspect of the invention there is provided an information processing device which realizes the function of displaying an exact print preview of document data on a display monitor quickly in the earliest possible timing after the document data are inputted.

In an embodiment of the invention which solves or reduces one or more of the above-mentioned problems, there is provided an information processing device which converts input document data into print data used to control a printer, and displays a print preview before outputting the print data to the printer, the information processing device comprising: a document data storing unit storing the input document data as intermediate data; a layout determining unit determining a layout of image data of the document data on an output sheet based on a specified printing method, so that layout information is created; a preview displaying unit displaying a print preview on a computer screen based on the stored document data; and a print data creating unit converting the input document data into the print data.

The above-mentioned information processing device may be configured so that the document data storing unit stores the image data contained in the input document data, as the intermediate data.

The above-mentioned information processing device may be configured so that the document data storing unit extracts the image data from the input document data, and stores the image data in a storage device on a document page basis as the intermediate data.

The above-mentioned information processing device may be configured so that the layout determining unit extracts print setting information and document page information from the input document data, and determines the arrangement of the image data on the output sheet based on the print setting information and the document page information.

The above-mentioned information processing device may be configured so that the layout determining unit determines arrangement information containing a position of a document page on an output sheet, a direction of rotation, and a scaling ratio, based on the print setting information, and outputs the arrangement information as the layout information.

The above-mentioned information processing device may be configured so that the preview displaying unit creates an output image based on the intermediate data and the layout information, and displays the output image on the computer screen.

The above-mentioned information processing device may be configured so that the print data creating unit converts the intermediate data into the print data based on the layout information created by the layout determining unit.

In an embodiment of the invention which solves or reduces one or more of the above-mentioned problems, there is provided a preview displaying method for use in an information processing device which converts input document data into print data used to control a printer, and displays a print preview before outputting the print data to the printer, the preview displaying method comprising the steps of: storing the input document data as intermediate data; determining a layout of image data of the document data on an output sheet based on a specified printing method, so that layout information is created; displaying a print preview on a computer screen based on the stored document data; and converting the input document data into the print data.

According to embodiments of the information processing device of the invention, it is possible to display an exact print preview on the computer screen quickly before the document data is converted into print data and the print data is outputted to the printer.

### BRIEF DESCRIPTION OF THE DRAWINGS

Other objects, features and advantages of the present invention will be apparent from the following detailed description when reading in conjunction with the accompanying drawings.

FIG. 1 is a block diagram showing the composition of an information processing device in an embodiment of the invention.

FIG. 2 is a block diagram showing the composition of a printer driver provided in the information processing device of FIG. 1.

FIG. 3 is a flowchart for explaining a normal printing procedure which is performed by the information processing device of FIG. 2 without performing a preview displaying.

FIG. 4 is a flowchart for explaining a preview displaying procedure which is performed by the information processing device of FIG. 2.

FIG. 5A and FIG. 5B are diagrams showing an example of layout information created by a layout determining unit of the information processing device of FIG. 2 and an example of a preview display corresponding to the layout information.

FIG. 6 is a flowchart for explaining a preview displaying procedure which is performed by the information processing device of FIG. 2 when the layout information is changed after preview displaying.

FIG. 7 is a block diagram showing the hardware composition of an information processing device in an embodiment of the invention.

### DETAILED DESCRIPTION OF PREFERRED EMBODIMENTS

A description will be given of an embodiment of the invention with reference to the accompanying drawings.

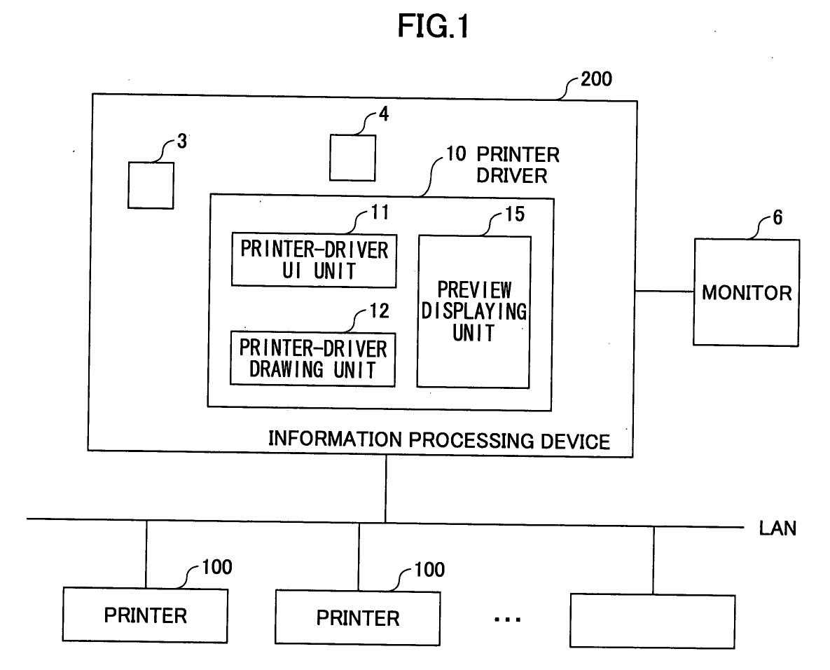

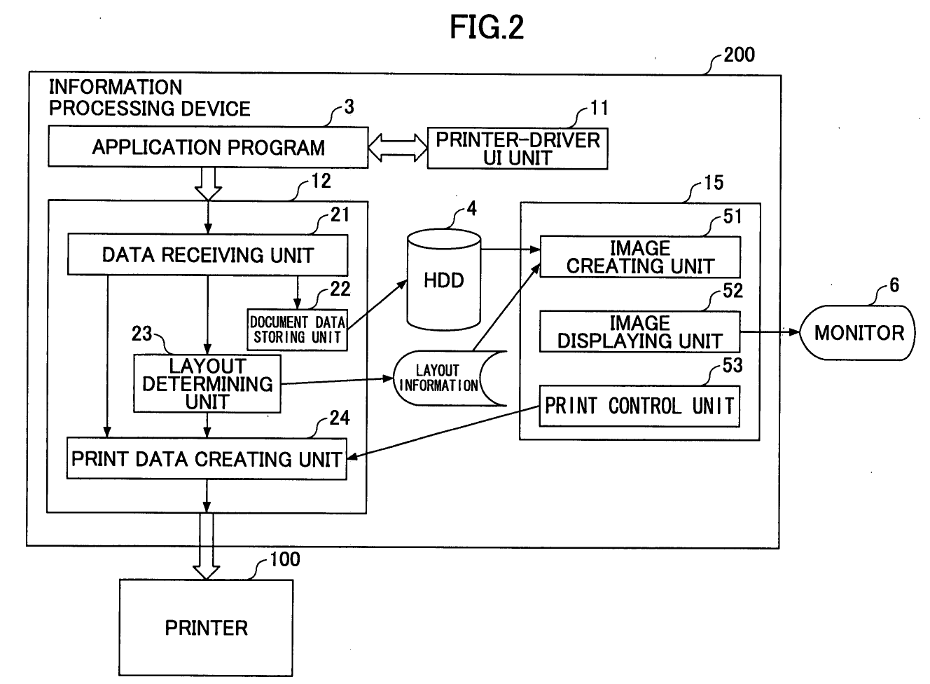

FIG. 1 is a block diagram showing the composition of an information processing device in an embodiment of the invention. FIG. 2 is a block diagram showing the composition of a printer driver provided in the information processing device of FIG. 1.

As shown in FIG. 1, the information processing device 200 comprises a printer driver 10, an application program 3, a hard disk drive 4, a display monitor 6, and a printer 100 connected to the information processing device 200 via LAN.

As shown in FIG. 1 and FIG. 2, the printer driver 10 of this embodiment comprises a printer driver UI (user interface) unit 11, a printer driver drawing unit 12, and a preview displaying unit 15.

Alternatively, the preview displaying unit 15 may be constituted as a software module which is separate from the printer driver 10.

The printer driver UI unit 11 is one of the software modules which constitute the printer driver 10, and this printer driver UI unit 11 is a graphical user interface which is adapted to perform various print setting functions which are provided by the printer and the printer driver.

The printer driver drawing unit 12 is one of the software modules which constitute the printer driver 10, and this printer driver drawing unit 12 receives the document data inputted by the application program 3, and converts the document data into print data (or, PDL data) which are used to control the printer.

As shown in FIG. 2, in the printer driver drawing unit 12, a data receiving unit 21 receives the input document data from the application program 3 in accordance with the predetermined interface which is specified beforehand by the OS (operating system). A document data storing unit 22 extracts image data from the input document data received by the data receiving unit 21, and stores the image data in the hard disk drive 4 on the basis of a document page as intermediate data. Namely, the image data (or the intermediate data) stored in the hard disk drive 4 contain one or a plurality of document page data items.

A layout determining unit 23 extracts document page information, output paper information, and print setting information from the input document data received by the data receiving unit 21, and determines the arrangement (layout) of the image data on the output sheet based on the extracted information, so that layout information is created.

Incidentally, the document data, which are received from the application program 3, contain initially at least the image data, the document page information, the output paper information, and the print setting information.

A print-data creating unit 24 performs the processing of movement, scaling, rotation, etc. of the image data stored in the hard disk drive 4 based on the layout information created by the layout determining unit 23. The print-data creating unit 24 converts the processed image data into the print data (PDL data), and transmits the print data to the printer 100.

As shown in FIG. 1, the preview displaying unit 15 in this embodiment is one of the software modules which constitute the printer driver 10, and this preview displaying unit 15 creates a print image (or print preview) based on the image data stored in the hard disk drive 4 by the document data storing unit 22 and based on the layout information created by the layout determining unit 23, and displays the print preview on the screen of the monitor 6.

As shown in FIG. 2, in the preview displaying unit 15, an image creating unit 51 reads the stored document page data from the hard disk drive 4, and creates the print image being displayed on the screen of the monitor 6, based on the layout information. An image displaying unit 52 displays the print image, created by the image creating unit 51, on the screen of the monitor 6 as a print preview.

A print control unit 53 transmits again the document page information and the layout information, which are stored, to the printer driver drawing unit 12, so that a final printing operation is performed on the printer 100 by the printer driver drawing unit 12.

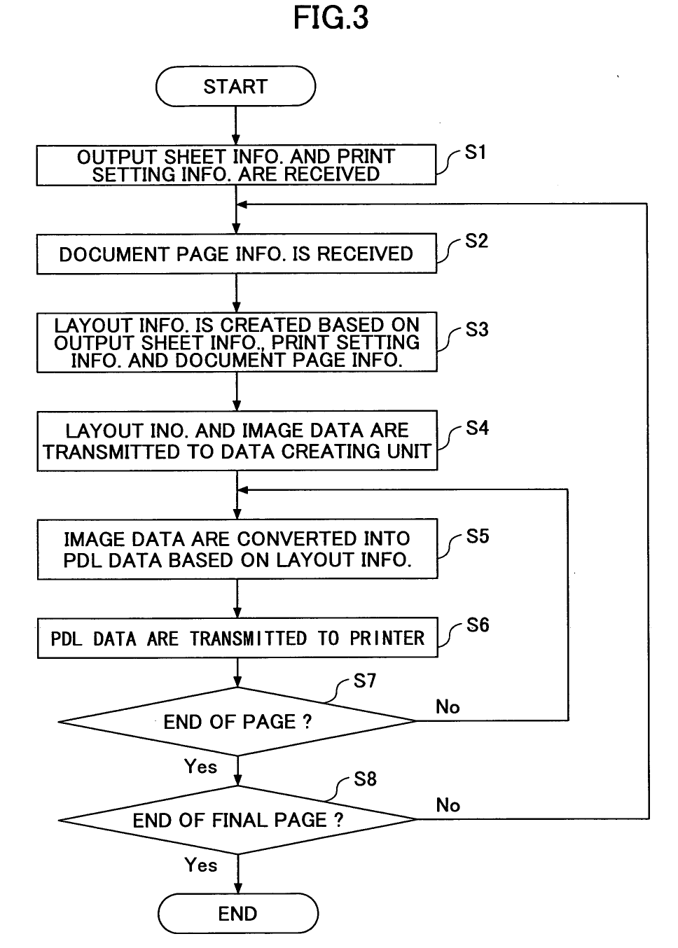

FIG. 3 is a flowchart for explaining a normal printing procedure which is performed by the information processing device of FIG. 2 without performing preview displaying.

As shown in FIG. 3, the data receiving unit 21 of the printer driver drawing unit 12 receives the output paper information and the print setting information from the document data inputted from the application program 3, and transmits such information to the layout determining unit 23 (S1).

In this embodiment, the output paper information and the print setting information are received in the step S1 as separate print information units. Alternatively, this receiving step may be performed so that the data receiving unit 21 receives a single print information unit containing both the output paper information and the print setting information from the document data.

Next, the printer driver drawing unit 12 receives the document page information from the inputted document data, and transmits the document page information to the layout determining unit 23 (S2).

Next, the layout determining unit 23 determines the arrangement (layout) of the image data on the output sheet based on the document page information, the output paper information and the print setting information, and creates layout information (S3).

The layout determining unit 23 transmits the created layout information to the print data creating unit 24 (S4).

The printer driver drawing unit 12 transmits the image data of a corresponding page of the document data inputted from the application program 3, to the print data creating unit 24 one by one (S4).

The print data creating unit 24 performs the processing of movement, scaling, rotation, etc. of the received image data based on the drawing position information of the corresponding document page obtained from the layout information created by the layout determining unit 23, and converts the processed document data into PDL data (S5).

The print data creating unit 24 transmits the created PDL data to the printer 100 (S6).

Next, the printer driver drawing unit 12 determines whether the transmitting processing of the print data for the image data of the corresponding page has ended (S7). The procedure of the above steps S5 and S6 is continuously performed until it is determined that the transmitting processing for the corresponding page has ended.

Finally, the printer driver drawing unit 12 determines whether the transmitting processing of the print data for the image data of the final page of the inputted document data has ended (S8). The procedure of the above steps S2-S7 is continuously performed until it is determined that the transmitting processing for the final page has ended.

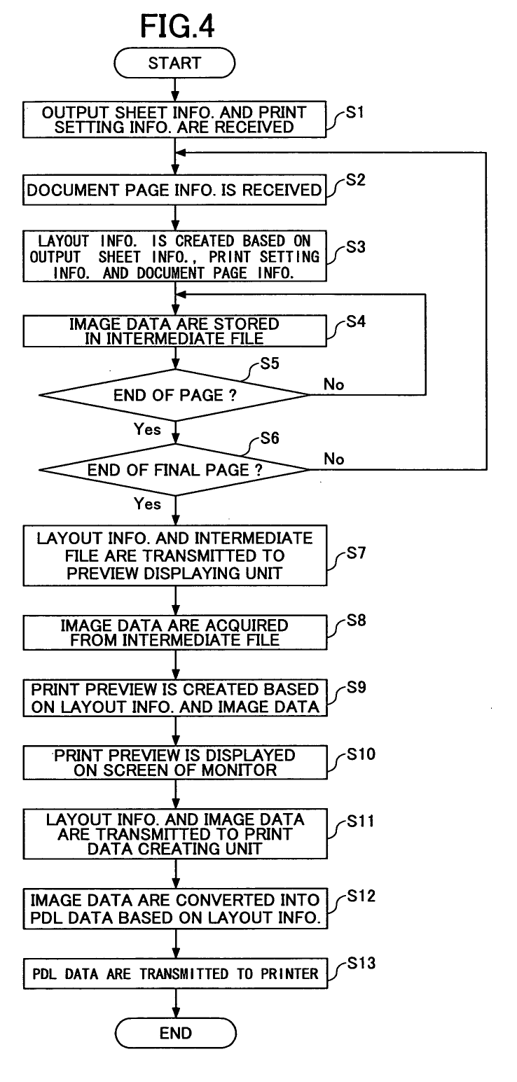

FIG. 4 is a flowchart for explaining a preview displaying procedure which is performed by the information processing device of FIG. 2.

As shown in FIG. 4, the data receiving unit 21 of the printer driver drawing unit 12 receives the output paper information and the print setting information from the document data inputted from the application program 3, and transmits such information to the layout determining unit 23 (S1).

In this embodiment, the output paper information and the print setting information are received in the step S1 as separate print information units. Alternatively, this receiving step may be performed so that the printer driver drawing unit 12 receives a single print information unit containing both the output paper information and the print setting information.

Next, the printer driver drawing unit 12 receives the document page information from the inputted document data, and transmits the document page information to the layout determining unit 23 (S2).

Next, the layout determining unit 23 determines the arrangement (layout) of the image data on the output sheet based on the document page information, the output paper information and the print setting information, and creates layout information (S3). In this step S3, the layout determining unit 23 transmits the created layout information to the preview displaying unit 15.

Next, the printer driver drawing unit 12 transmits the image data of a corresponding page of the document data inputted from the application program 3, to the document data storing unit 22 one by one, and stores the image data in the hard disk drive 4 as an intermediate file of the document data (S4).

Next, the printer driver drawing unit 12 determined whether the storing processing of the image data of the corresponding page has ended (S5). The procedure of the above step S4 is continuously performed until it is determined that the storing processing for the corresponding page has ended.

Next, the printer driver drawing unit 12 determines whether the storing processing of the image data of the final page of the inputted document data has ended (S6). The procedure of the above steps S2-S5 is continuously performed until it is determined that the storing processing for the final page has ended.

When the processing for all the pages of the document data is completed, the printer driver drawing unit 12 transmits a variety of the relevant information items (the output paper information, the layout information and others) to the preview displaying unit 15 (S7). Then, the preview displaying unit 15 starts operation.

The image creating unit 51 of the preview displaying unit 15 reads the layout information, and reads the image data of the corresponding document page from the stored intermediate file of the hard disk drive 4 (S8).

The image creating unit 51 creates a print image (print preview) of the image data being displayed on the screen of the display monitor 6, based on the layout information (S9).

The image displaying unit 52 displays the print image (print preview) created by the image creating unit 51, on the screen of the monitor 6 (S10). If the user checks the print preview displayed on the screen of the monitor 6 and inputs a printing execution request, then the print control unit 53 transmits the layout information and the image data to the print data creating unit 24 one by one (S11).

Next, the print data creating unit 24 performs the processing of movement, scaling, rotation, etc. of the image data received from the preview displaying unit 15 based on the drawing position information of the corresponding document page obtained from the layout information received from the preview displaying unit 15, and converts the processed document data into PDL data (S12).

Finally, the print data creating unit 24 transmits the created PDL data to the printer 100 (S13).

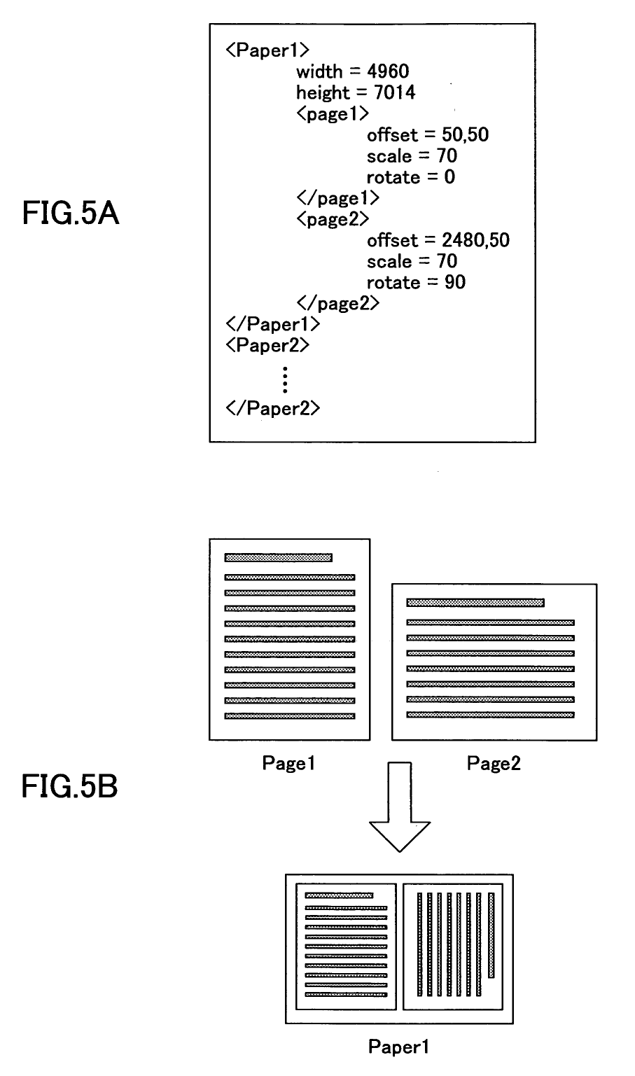

Next, an example of the layout information will be explained. FIG. 5A and FIG. 5B show an example of the layout information created by the layout determining unit of the information processing device of FIG. 2 and an example of a preview display corresponding to the layout information.

In the example of the layout information shown in FIG. 5A, “Paper1” and “Paper2” denote output sheets, “width” and “height” following “Paper1” denote the size (width and height) of the output sheet.

In the “Paper1” part of the layout information, the information on the document page arranged on the output sheet is described. The information on each document page is described as page1 to pageN. In this example, the numerical value of N is determined depending on the number of pages of intensive print setting.

Arrangement information, such as “offset”, “scale”, and “rotate”, is described in the part of each page of the layout information. In FIG. 5A, “offset” denotes the coordinates of the origin point of image data of a corresponding document page on the output sheet, “scale” denotes the scaling ratio of image data of a corresponding document page, and “rotate” denotes the direction of rotation of image data of a corresponding document page, respectively.

FIG. 5B shows an example of the preview display corresponding to the layout information shown in FIG. 5A. The layout determining unit 23 creates the layout information based on intensive printing setting information, a document page size, and an output paper size, which are in conformity with a printing method specified by the user.

The print data creating unit 24 creates the PDL data from the image data based on this layout information.

The preview displaying unit 15 creates the data of a print image from the image data based on this layout information. Namely, even when the layout information created by the layout determining unit 23 is subsequently changed (e.g., change of the direction of the print image at the time of intensive printing), it is not necessary to change the fundamental operation of the preview displaying unit 15 if the contents of the layout information are already obtained.

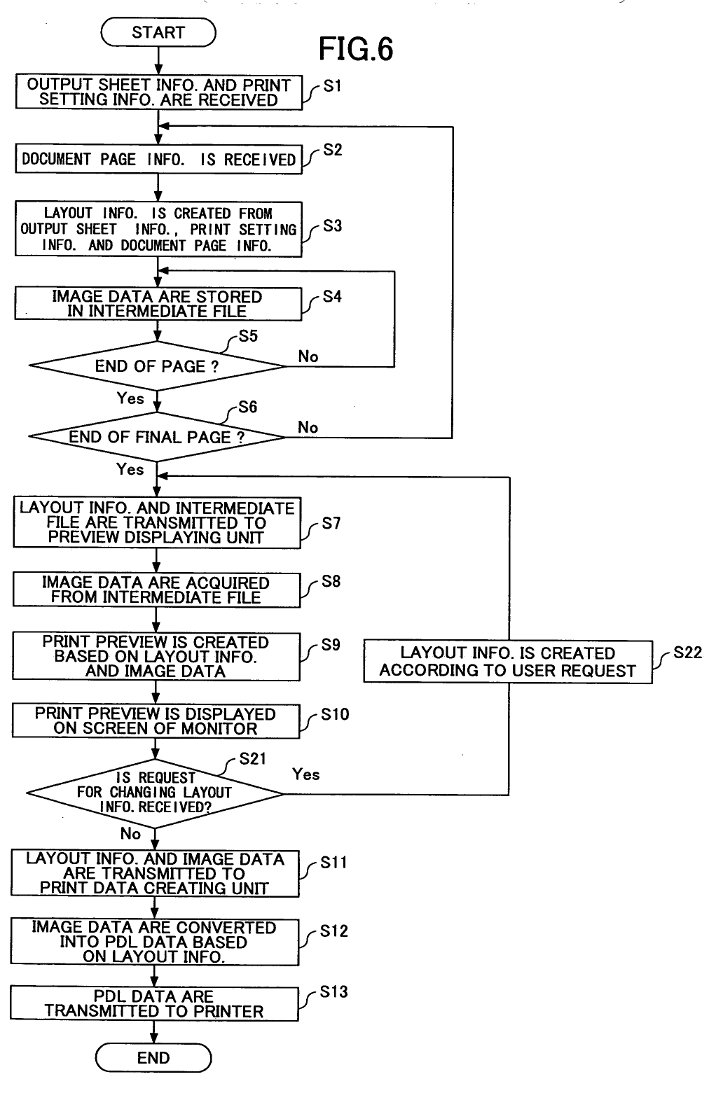

FIG. 6 is a flowchart for explaining a preview displaying procedure which is performed by the information processing device of FIG. 2 when the layout information is changed after preview displaying.

In the flowchart of FIG. 6, the procedure of steps S1-S13 is essentially the same as the procedure of the above-mentioned steps S1-S13 in the flowchart of FIG. 4, and a description of these steps will be omitted.

As shown in FIG. 6, after the print image (print preview) created by the image creating unit 51 is displayed on the screen of the monitor 6 by the displaying unit 52 in step S10, the preview displaying unit 15 determines whether a request for changing the layout information is received from the user (S21).

The user checks the print preview displayed on the screen of the monitor 6. If the user inputs a layout changing request with respect to the print preview, the control of the preview displaying unit 15 is shifted to the following step S22.

In step S22, the preview displaying unit 15 changes the layout information received from the printer driver drawing unit 12, in accordance with the layout changing request from the user, and performs the procedure of the above-mentioned steps S7-S10 again.

When the result of the determination in the step S21 is negative (or, when there is no input of the layout changing request from the user), the control of the preview displaying unit 15 is shifted to the following step S1.

The procedure which is the same as the procedure of the above-mentioned steps S11-S13 in the flowchart of FIG. 4 is performed.

Therefore, according to the procedure of FIG. 6, even when the user changes the layout information created by the layout determining unit 23, it is possible to promptly take countermeasure to the layout changing request from the user. Since the format of the layout information created by the layout determining unit 23 is already received, what is performed by the preview displaying unit 15 in this case is to change only a part of the format of the received layout information, and it is possible to promptly take countermeasure to the layout changing request from the user.

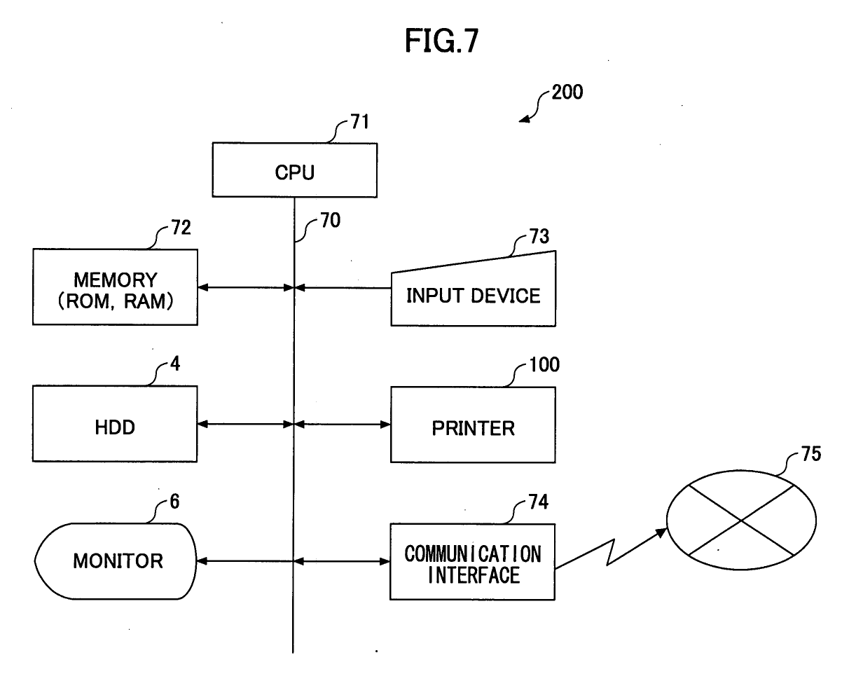

FIG. 7 is a block diagram showing the hardware composition of an information processing device in an embodiment of the invention.

As shown in FIG. 7, the information processing device 200 is constituted by a general-purpose computer, such as a personal computer.

The information processing device 200 comprises a CPU 71 and a memory 72 which are connected by a bus 70. The CPU 71 is adapted to perform various operations and control respective parts of the information processing device intensively. The memory 72 includes a ROM and a RAM.

In the information processing device 200, the hard disk drive (HDD) 4 is connected to the bus 70 via a predetermined interface. Moreover, an input device 73 including a mouse, a keyboard, etc., a predetermined communication interface 74, the display monitor 6, such as LCD or CRT, and the printer 100 are connected to the bus 70. The communication interface 74 is adapted for the information processing device 200 to communicate with an external device on a network 75, such as a LAN or the Internet.

In the information processing device 200 of FIG. 7, the printer driver 10 which has been explained with reference to FIG. 2 is recorded beforehand on the ROM of the memory 72. Upon starting of the information processing device 200, the printer driver 10 recorded on the ROM is read and loaded to the RAM of the memory 72, and the procedure (preview display program) of FIG. 4 or FIG. 6 is performed under the control of the CPU 71.

In the information processing device 200 of FIG. 7, when the preview displaying program is executed by the CPU 71, the CPU 71 functions as the document data storing unit, the layout determining unit, the preview displaying unit, and the print data creating unit.

The document data storing unit stores the document data inputted by the application program 3, into the HDD 4 as intermediate data. The layout determining unit determines the arrangement of the image data on the output sheet based on the printing method specified by the user on the input device 73, and creates the layout information.

The preview displaying unit displays a print preview on the screen of the monitor 6 based on the stored document data. The print data creating unit converts the intermediate data into print data, such as PDL data, based on the layout information.

In the composition of the information processing device 200 shown in FIG. 7, the printer driver 10 recorded beforehand on the ROM of the memory 72 constitutes the preview display program in an embodiment of the invention.

Alternatively, the information processing device 200 may be configured such that a recording media, such as a CD-ROM, on which the above printer driver 10 is recorded beforehand, is read by using a recording-medium reader (not illustrated), and the printer driver 10 read from the recording medium is installed in the RAM of the memory 72 or the HDD 4.

By this installation, the information processing device 200 is set in a state where it is adapted to carry out the above-mentioned procedure of FIG. 4 or FIG. 6. In this case, the printer driver 10 installed in the RAM of the memory 72 or the HDD 4 constitutes the preview display program in an embodiment of the invention.

As mentioned above, the information processing device 200 is capable of communicating with an external device on the network 75, such as the Internet, via the communication interface 74. Thus, the information processing device 200 may be configured by downloading the preview display program in an embodiment of the invention via the network, and installing it in the RAM of the memory 72 or the HDD 4. By this downloading, the information processing device 200 is set in a state where it is adapted to carry out the above-mentioned procedure of FIG. 4 or FIG. 6.

The preview display program of the invention may be configured to operate on a predetermined OS. The preview display program of the invention may be a program module which constitutes a part of a specific application program.

As described in the foregoing, in the information processing device of an embodiment of the invention, the layout determining unit which temporarily stores the document data inputted from the application program as intermediate data in a storage device, such as a hard disk drive, and the arrangement of the image data on the output sheet is determined, When it has the print data creating unit which converts document data into print data, such as PDL data, and the preview displaying unit receives the layout information from a the layout determining unit, it displays on a computer screen by making the same print image as an actual printed result into a print preview.

Therefore, according to the information processing device of the invention, it is possible to display an exact print preview of document data on the computer screen quickly before the document data is converted into print data and the print data is outputted to the printer.

The present invention is not limited to the above-described embodiments, and variations and modifications may be made without departing from the scope of the present invention.

Further, the present application is based on and claims the benefit of priority of Japanese patent application No. 2005-328176, filed on Nov. 11, 2005, and Japanese patent application No. 2006-298261, filed on Nov. 1, 2006, the entire contents of which are hereby incorporated by reference.

What is claimed is:

1. An information processing device which converts input document data into print data used to control a printer, and displays a print preview before outputting the print data to the printer, the information processing device comprising:
a document data storing unit storing the input document data as intermediate data;
a layout determining unit determining a layout of image data of the document data on an output sheet based on a specified printing method, so that layout information is created;
a preview displaying unit displaying a print preview on a computer screen based on the stored document data; and
a print data creating unit converting the input document data into the print data.

2. The information processing device according to claim 1, wherein the document data storing unit stores the image data contained in the input document data, as the intermediate data.

3. The information processing device according to claim 2, wherein the document data storing unit extracts the image data from the input document data, and stores the image data in a storage device on a document page basis as the intermediate data.

4. The information processing device according to claim 1, wherein the layout determining unit extracts print setting information and document page information from the input document data, and determines the arrangement of the image data on the output sheet based on the print setting information and the document page information.

5. The information processing device according to claim 4, wherein the layout determining unit determines arrangement information containing a position of a document page on an output sheet, a direction of rotation, and a scaling ratio, based on the print setting information, and outputs the arrangement information as the layout information.

6. The information processing device according to claim 1, wherein the preview displaying unit creates an output image based on the intermediate data and the layout information, and displays the output image on the computer screen.

7. The information processing device according to claim 1, wherein the print data creating unit converts the intermediate data into the print data based on the layout information created by the layout determining unit.

8. A preview displaying method for use in an information processing device which converts input document data into print data used to control a printer, and displays a print preview before outputting the print data to the printer, the preview displaying method comprising the steps of:
storing the input document data as intermediate data;
determining a layout of image data of the document data on an output sheet based on a specified printing method, so that layout information is created;
displaying a print preview on a computer screen based on the stored document data; and
converting the input document data into the print data.

9. The preview displaying method according to claim 8, wherein the storing step is configured to store the image data contained in the input document data, as the intermediate data.

10. The preview display method according to claim 8, wherein the determining step is configured to extract print setting information and document page information from the input document data and determine the arrangement of the image data on the output sheet based on the print setting information and the document page information.

11. The preview displaying method according to claim 10, wherein the determining step is configured to determine arrangement information containing a position of a document page on an output sheet, a direction of rotation, and a scaling ratio, based on the print setting information, and output the arrangement information as the layout information.

12. A computer-readable recording medium having a computer-readable program stored thereon which, when executed by a computer, causes the computer to perform a preview displaying method for use in an information processing device which converts input document data into print data used to control a printer, and displays a print preview before outputting the print data to the printer, the preview displaying method comprising the steps of:
storing the input document data as intermediate data;
determining a layout of image data of the document data on an output sheet based on a specified printing method, so that layout information is created;
displaying a print preview on a computer screen based on the stored document data; and
converting the input document data into the print data.
